(19) United States
(12) Patent Application Publication
(10) Pub. No.: US 2020/0241794 A1
(43) Pub. Date: Jul. 30, 2020

(54) LOW LATENCY SWAP DEVICE, SYSTEM AND METHOD

(71) Applicant: Goke US Research Laboratory, Santa Clara, CA (US)

(72) Inventor: Engling Yeo, San Jose, CA (US)

(21) Appl. No.: 16/256,977

(22) Filed: Jan. 24, 2019

(51) Int. Cl. G06F 3/06; G06F 12/02

(52) U.S. Cl. CPC G06F 3/0659; G06F 3/0679; G06F 3/061; G06F 2212/401; G06F 2212/7203; G06F 2212/402; G06F 12/0246

(57) ABSTRACT

A system, method and apparatus is described for providing low-latency swap operations in a computer system. Swap memory space is defined by physical location attributes of non-volatile memory in a data storage device. The physical location attributes are used by a processor to directly store swap data into the data storage device at a location in accordance with the physical location attributes. No address translation is performed by either the processor or the data storage device.

### BACKGROUND

### I. Field of Use

The present invention relates to the field of computer data storage and more specifically to low latency, high speed data storage and retrieval with a data storage device.

### II. Description of the Related Art

A computer system may divide a magnetic hard drive into two or more partitions, one used for long-term data storage and another to be used solely as a “swap device”. A swap device is used when the amount of physical memory (RAM or DRAM) in the computer is full, typically as a result of having many executable programs running. If the physical memory is full, inactive memory pages in the physical memory may be moved to the swap device to make more physical memory available. However, using this technique greatly increases the access time needed to retrieve such inactive pages from the hard drive or SSD.

Recently, very high speed solid state hard drives (SSDs) have been introduced into the market. These hard drives typically transfer data at several times the rate of traditional magnetic hard drives. For example, a typical magnetic hard drive may be capable of transferring 50-120 megabytes of data per second, while modern SSDs may allows speeds up to 12 gigabytes per second, using cutting edge data transfer protocols such as Non-Volatile Memory express (NVMe). However the NVMe specification is written for SSDs that use non-volatile NAND memory with access time requirements typically in the 100 us range, and overall read latencies in the neighborhood of 1 ms. While the access time and read latencies are much faster than traditional magnetic hard drives, it still not fast enough to store or retrieve pages seamlessly, causing noticeable delays. Moreover, to obtain the fast transfer rates possible, the cost of such SSDs may be prohibitively expensive for average users.

The NVMe specification defines one or more submission queues within the computer memory and uses doorbell registers in a PCIe base address register (BAR) space to notify a solid state hard drive (SSD) of every new submission queue entry. The SSD then retrieves the command, followed by any write-data from the computer. The write-data is defined as the data that is intended to be written to the non-volatile media. Likewise, the NVMe specification defines one or more completion queues within the computer memory, and the SSD interrupts the computer after a completion queue entry has been written by the SSD. Traditional SSDs use firmware to perform mapping between logical block address provided by the computer and physical block addresses that reference the actual physical addresses in non-volatile memory used in the SSD. In traditional computing systems, a host driver maps a particular virtual memory page to a logical block address in the storage device, and the storage device further maps the logical block address to a physical block address in the non-volatile memory. The added layer of using a logical block address as an intermediary between the compute and the SSD is what introduces additional delays when reading or writing information to or from the SSD.

It would be desirable, therefore, eliminate the intermediary step of having to define logical block addresses by the computer, in order to reduce the latency when storing and retrieving data to a minimum.

### SUMMARY

The embodiments herein describe a low-latency swap device, system and method. In one embodiment, a computer system is described, coupled to a data storage device, comprising a data storage device interface, a data storage device coupled to the data storage interface, comprising a non-volatile memory for storing swap data associated with one or more applications being executed by the computer system, a memory for storing processor-executable instructions comprising operating system instructions, application instructions associated with the one or more applications and application data, a processor coupled to the data storage device interface and the memory for executing the processor-executable instructions that causes the computer system to determine, by the processor, a need to swap some of the application instructions and/or the application data in the memory to the data storage device, in response to determining a need to store some of the application instructions and/or the application data, identify, by the processor, a quantity of the application instructions and/or the application data for storage to the data storage device as swap data, determine, by the processor, a physical location in the non-volatile memory where the swap data will be stored, the physical location comprising a physical address of the non-volatile memory, generate, by the processor, a write command comprising the physical location and send, by the processor, the write command to the data storage device via the data storage device interface.

In another embodiment, a data storage device coupled to a computer system is described, for providing low-latency data storage and retrieval, comprising a computer interface, a first non-volatile memory for storing swap data associated with one or more applications being executed by the computer system, a memory for storing processor-executable instructions, and a controller coupled to the computer interface, the first non-volatile memory and the memory, for executing the processor-executable instructions that cause the data storage device to receive, by the processor via the computer interface, a write command from the computer system, the write command comprising a physical location in the non-volatile memory where the swap data should be stored, the physical location comprising a physical address of the non-volatile memory, receive, by the processor via the computer interface, the write command from the computer system, and store the swap data in the first non-volatile memory in accordance with the physical address provided by the write command.

In yet another embodiment, a method, performed by a computer system coupled to a data storage device is described, comprising determining, by a processor, a need to store a quantity of application instructions and/or application data from a memory coupled to the processor to a data storage device, in response to determining a need to store the quantity of the application instructions and/or application data in the memory to the data storage device, identifying, by the processor, some of the application instructions and/or application data as swap data to be stored in the data storage device, determining, by the processor, a physical location in the non-volatile memory where the swap data will be stored, the physical location comprising a physical address of the non-volatile memory, generating, by the processor, a write command comprising the physical address, and sending, by the processor, the write command to the data storage device via a data storage device interface.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a functional block diagram of one embodiment of a computer system using the inventive concepts described herein;

FIG. 2 illustrates a functional block diagram of one embodiment of a data storage device as shown in FIG. 1; and

FIGS. 3A, 3B and 3C illustrate a flow diagram of one embodiment of a method performed by a host processor and the data storage device as shown in FIG. 1, to provide low-latency data storage and retrieval during a swap operation.

### DETAILED DESCRIPTION

Methods and apparatus are described herein for providing low-latency read and write operations during swap operations for computers, that significantly lowers the amount of time required for memory access. In one embodiment, a variation of the well-known NVMe protocol, or the NVMe Over Fabrics (NVMe-OF), is used as a data transfer protocol between a host processor and a data storage device, such as a solid state hard drive (SSD). NVMe is defined by a specification which can be found at https://nvmexpress.org/, presently version 1.3, dated May 1, 2017, published by NVM Express, Inc. and incorporated by reference herein in its entirety. NVMe-OF is defined by a specification which can also be found at https://nvmexpress.org/, entitled, “NVM Express over Fabrics, Revision 1.0” dated Jun. 5, 2016, also published by NVM Express, Inc., and also incorporated by reference herein in its entirety.

In one embodiment that utilizes NVMe or NVMe-oF, the use of doorbell registers and address translation by a SSD may be avoided when a controller of a data storage device comprises an integrated memory buffer, thus greatly improving read and write latencies.

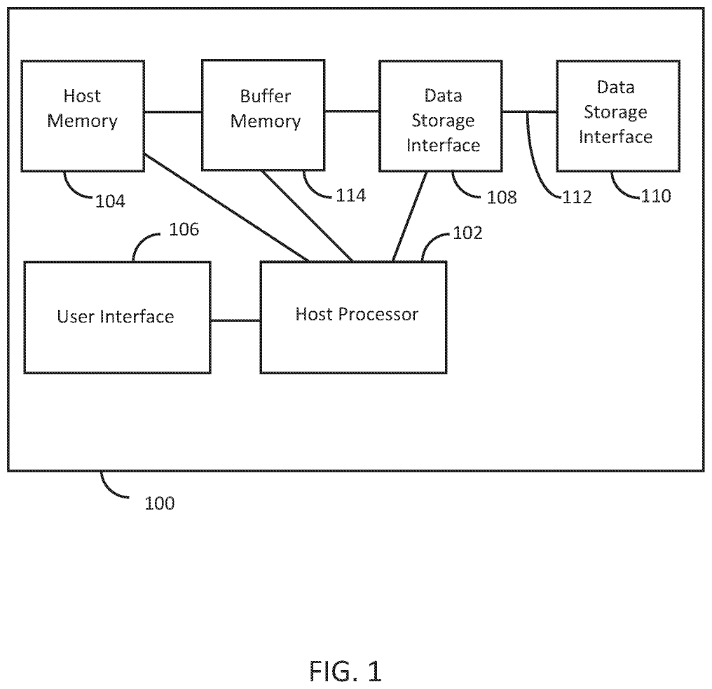

FIG. 1 illustrates a functional block diagram of one embodiment of a computer system 100 using the inventive concepts described herein. Shown is computer system 100, comprising host processor 102, host memory 104, user interface 106, data storage interface 108, data storage device 110, high-speed information bus 112 and buffer memory 114.

Computer system 100 may comprise a personal computer, laptop, tablet computer, or server used to execute a variety of software applications such as word processing, web browsing, email, or certain specialized tasks, such as enterprise data storage. The applications are typically initiated by a user via user interface 106. In response, processor 102 loads executable instructions, or code, typically from data storage device 110 into host memory 104, representative of the application that was initiated. Processor 102 then executes the code in host memory 104 that causes the application to run on computer system 100. Multiple applications may run simultaneously, as is well known in modern day operating systems.

Processor 102 may additionally load one or more data files to support the applications, such as a database for spreadsheet applications, text documents for word processing applications, digital photos or video for photo editing applications, etc.

Prior to loading application code into host memory 104, processor 102 may determine whether sufficient memory space is available in host memory 104, based on the size of the application code to be loaded, and the remaining, unused memory space in host memory 104. When processor 102 determines that not enough space is available, processor 102 may select one of the applications, or one or more data files associated with the applications, for removal from host memory 104 and storage within a “swap space”, or temporary storage, of the data storage device 110. In addition, processor 102 may replace the data that is sent to the data storage device with either a new application and associated data stored by the data storage device, or an application/data that was previously stored in the swap space. The above process may be referred to herein as a “swap” operation, where applications/data stored either in host memory 104 or the swap space are referred to herein as “swap data”. The swap operation essentially extends the size of host memory 104, with the swap space on data storage device 110 referred to as a virtual memory of host memory 104. The swap operation allows a greater number of applications to run on computer system 100 than would otherwise be permitted, as the capacity of host memory 104 is consumed. Unlike prior art systems, however, processor 102 uses a physical address, and other physical memory attributes, of memory designated as swap space inside data storage device 110, rather than a defining a virtual address by processor 102 that gets mapped into a physical address by a prior art data storage device.

Processor 102 is configured to provide general operation of computer system 100 by executing processor-executable instructions (i.e., executable code) stored in host memory 104 representing the operating system and one or more software applications. Processor 102 typically comprises a general purpose microprocessor or microcontroller manufactured by Intel Corporation of Santa Clara, Calif. or Advanced Micro Devices of Sunnyvale, Calif., selected based on computational speed, cost and other factors.

Host memory 104 is coupled to processor 102 and comprises one or more non-transitory information storage devices, such as random access memory (RAM, DRAM), flash memory, or other type of volatile or non-volatile electronic, optical, or mechanical memory device. Host memory 104 typically stores an operating system of computer system 100, as well as one or more software applications, in executable form, and related data files. Host memory 104 also stores the instructions needed to perform low-latency data transfers between host memory 104 and data storage device 110 and, in some embodiments, instructions to compress and/or encrypt the swap data as described later herein. It should be understood that in some embodiments, a portion of memory 104 may be embedded into processor 102 and, further, that memory 104 excludes media for propagating signals. It should also be understood that the instructions to perform low-latency data transfers between host memory 104 and data storage device 110 may be part of the operating system instructions.

User interface 106 is coupled to processor 102 and allows a user to control operation of computer system 100. User interface 106 may comprise a keyboard, keypad, touch-screen device, microphone, etc., that generates electronic signals for use by processor 102 upon initiation by a user. User interface 106 may additionally comprise one or more a liquid crystal displays (LCDs), light emitting diode displays (LEDDs), light emitting diodes (LEDs), light arrays, or any other type of visual display. Further, user interface 106 could comprise an audio device, such as a speaker, for audible presentation of information to a user.

Data storage interface 108 may be coupled to host processor 102, buffer memory 114 host memory 104 and information bus 112, comprising circuitry and protocols that provide low-latency data transfers between host processor 102 and data storage device 110 via information bus 112. In one embodiment, data storage interface 108 and information bus 112 conform to the well-known Peripheral Component Interconnect Express, or PCIe, standard, although one of any number of modern high-speed information busses may be used instead. PCIe is a high-speed serial computer expansion bus standard designed to replace older PCI, PCI-X, and AGP bus standards.

Data storage device 110 is coupled to processor 102, host memory 104 and/or buffer memory 114 via information bus 112 and data storage interface 108, comprising one or more non-transitory, internal or external non-volatile data storage devices, such as one or more solid state drives (SSDs), or other high-speed data storage devices. Data storage device 110 is typically the main data storage component n computer system 100, storing the operating system, executable applications, and user data, such as word-processing files, digital photographs and videos, music files, etc. Data storage device 110 is typically able to store many hundreds of megabytes or even terabytes of applications and data. It should be understood that data storage device 110 excludes media for propagating signals. As will be explained later herein, data storage device 110 may comprise a number of non-volatile memory devices for storing the swap data in an area designated as swap space as one or more physical memory pages, i.e., a fixed-length contiguous block of the non-volatile memory devices. Such fixed-length, contiguous blocks are generally 4 k bytes or 8 k bytes in size.

Buffer memory 114 is coupled to processor 102 and to data storage interface 108, used in some embodiments to temporarily store data destined for data storage device 110, as well as to temporarily store data retrieved from data storage device 110. Buffer memory 114 generally comprises RAM or DRAM, due to its high-speed data transfer abilities. In some embodiments, buffer memory 114 is part of memory 104 and/or part of processor 102. In any case, buffer memory 114 excludes media for propagating signals.

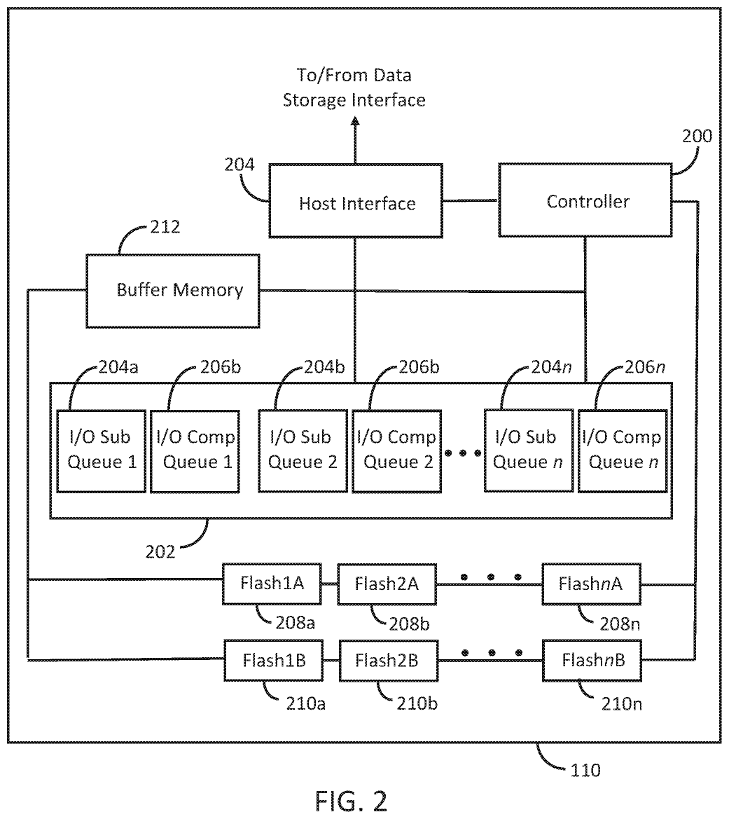

FIG. 2 illustrates a functional block diagram of data storage device 110. It should be understood that the functional components shown in FIG. 2 could be coupled to one another in a number of different arrangements, that not all of the functional blocks may be necessary for data storage device 110 to function in its intended manner, and that not all functional blocks are shown, in order to focus on the blocks needed for implementation of the embodiment.

In this embodiment, data storage device 110 comprises controller 200, memory 202, computer system interface, 204 and a plurality of non-volatile memory units 208a-n and 210a-n, where n represents the n^{th} non-volatile memory unit. In one embodiment, during an initialization process, processor 102 allocates a portion of memory space of non-volatile memory units 208a-n and 210a-n as swap memory space to store or retrieve application instructions and/or application data during swap operations. In another embodiment, “initialization” may happen at any time, i.e., designated more, or less, swap memory space, even after an initial swap memory space has been defined, without having to reformat data storage device 110. The swap memory space is defined by the actual, physical memory addresses of non-volatile memory units 208a-208n and 210a-210n, rather than by virtual addresses, as used in prior art systems.

In one embodiment, processor 102 defines a number of I/O queues 204, shown as I/O submission queues 204a-204n, and a number of I/O completion queues 206a-206n. These queues are similar to I/O submission and completion queues used by the well-known NVMe or NVMe over fabrics (NVMe-oF) protocols. In one embodiment, some I/O queues are designated for swap operations, while others are designated for non-volatile storage that occurs during normal storage operations, such as when storing data or applications for long-term storage. Such designation may be assigned by processor 102 and stored in an address table maintained by processor 102 and stored in memory 104.

When processor 102 determines that a swap operation is desired or needed, processor 102 may generate a write command and send the write command to data storage device 110 via, in one embodiment, buffer memory 114, data storage interface 108, information bus 112 and host interface 204. In one embodiment, the write command comprises some or all of the data to be stored and a physical location in one or more of the non-volatile memories 208a-n or 210a-n where to store the data. In another embodiment, the write command does not comprise the data to be stored. In this embodiment, the data to be stored is written to buffer 114 at a particular location, and the write command comprises an identification in buffer 114 of the particular location where the data may be found. The write command further comprises an identification of a physical location in one or more of the non-volatile memories 208a-n and/or 210a-n where to store the data. In either case, controller 200 does not perform a translation of the physical location provided by processor 102, because the physical location directly identifies an address, channel, bank, plane, or other physical attribute of a particular location in one or more of the non-volatile memories 208a-n and 210a-n where the swap data will be stored by controller 200. This is unlike prior art systems, where controller 200 typically receives a virtual address from processor 102, converts the virtual address to a physical address of one or more of the non-volatile memories 20a-n and 210a-n, and then stores the swap data in one or more of the non-volatile memories 208a-n or 210a-n in accordance with the physical address.

In one embodiment, the write command is formatted in compliance with a vendor-specific command as defined by the NVMe protocol, which allows customized vendor-defined commands. Fields within the vendor-specific command may be defined to communicate various parameters to controller 200 for use during swap operations, such as a physical starting address where to store the data in one of the non-volatile memories, a channel, bank or plane of the non-volatile memory unit, etc. The write command, thus, comprises a customized vendor-specific write command, as described in greater detail later herein. Controller 200 processes the customized vendor-specific write command to retrieve the swap data from host memory 104, or buffer 114, and store the swap data in a location in one or more of the non-volatile memories identified by the customized vendor-defined write command, without performing any address translation.

Similarly, host processor 102 may determine that swap data from the swap memory space should be retrieved from data storage device 110 and stored in memory 104. In this case, processor 102 may generate a read command and send the read command to data storage device 110 via, in one embodiment, buffer memory 114, data storage interface 108, information bus 112 and host interface 204. The read command comprises a physical location in one of the non-volatile memories 208 or 210 where the swap data was previously stored and, in one embodiment, a location in memory 104, or memory buffer 114, where the swap data should be placed after retrieval from the particular non-volatile memory(ies). Controller 200 does not perform a translation of the physical location of the particular non-volatile memory provided by processor 102, because the physical location directly identifies the memory space within the particular non-volatile memory(ies) where the data may be found, unlike prior art systems, where controller 200 would typically receive a virtual address from processor 102 and then have to translate the virtual address into a physical address using, for example, a lookup table.

In one embodiment, the read command is formatted in compliance with a vendor-specific command as defined by the NVMe protocol, which allows customized vendor-defined commands. Fields within the vendor-specific command may be defined to communicate various parameters to controller 200 for use during swap operations, such as a physical starting address where to find the data in one of the non-volatile memory units, a channel, bank or plane of the non-volatile memory unit, etc. The read command, thus, comprises a customized vendor-specific read command, as described in greater detail later herein. Controller 200 processes the customized vendor-specific read command to retrieve the swap data from a location in the non-volatile storage unit device identified by the customized vendor-defined read command without performing any address translation. Then, controller 200 provides the swap data to host memory 104, or buffer 114, in accordance with the parameters provided in the customized vendor-specific read command.

Controller 200 is configured to provide general operation of data storage device 110 by executing processor-executable instructions stored in memory 202, for example, executable computer code. Controller 200 comprises one or more microprocessors, microcontrollers, custom ASICs, PGAs, and/or similar circuitry, and/or peripheral circuitry to execute processor-executable code stored in memory 202. The microprocessors, microcontrollers, custom ASICs, and/or PGAs, are selected based on factors such as speed, cost, and other capabilities.

Controller memory 202 comprises one or more non-transitory information storage devices, such as RAM, DRAM, flash memory, or other type of electronic, optical, or mechanical memory device. Controller memory 202 is used to store processor-executable instructions for operation of data storage device 110 including, in some embodiments, instructions to decompress and/or decrypt the swap data. In some embodiments, controller memory 202 is also used to store one or more I/O submission queues, and one or more I/O completion queues, used in an embodiment where the NVMe protocol, or NVMe-oF protocol, is used. It should be understood that in some embodiments, controller memory 202 is incorporated into controller 200 and, further, that controller memory 202 excludes media for propagating signals.

Host interface 204 comprises circuitry and firmware to support a physical connection and logical emulation to host processor 102 via information bus 112, buffer memory 114, and/or host memory 104. Such circuitry is well-known in the art.

Buffer memory 212 is used in come embodiments, comprising one or more data storage devices for providing temporary storage for data to be stored in non-volatile memory units 208a-n and 210a-n for data to be sent to processor 102, memory 104 and/or buffer 114. Buffer 212 may be used, in some embodiments, to store 110 and administrative commands in I/O submission and administrative queues. Buffer 212 typically comprises RAM or DRAM memory for fast access to the swap data.

Non-volatile memory units 208a-n and 210a-n are coupled to buffer 212 and controller 200, comprising one or more non-transitory information storage devices, such as flash memory, or other type of non-volatile, electronic, optical, or mechanical memory device, used to store large amounts of data in the form of applications, an operating system, and data related to the applications and the operating system. A portion of non-volatile memory 208a-n and 210a-n is used as a swap memory space to store executable application instructions and application data from host memory 104, in one embodiment as physical memory pages, when host memory 104 approaches capacity. Non-volatile memory 208a-n and 210a-n exclude media for propagating signals.

In one embodiment, non-volatile memory 208a-n and 210a-n comprise a number of NAND flash memory chips, arranged in a series of physical banks, channels and/or planes, to provide up to multiple terabytes of data storage. One bank of memory chips are shown in FIG. 2 as non-volatile memory 208a-n, while a second bank is shown as non-volatile memory 210a-n. Channels may be defined as “parallel” non-volatile memory. For example, in FIG. 2, non-volatile memories 208a and 210a form a first channel, non-volatile memories 208b and 210b form a second channel, and non-volatile memories 208n and 210n form an n^{th} channel. In some embodiments, each of the non-volatile memories 208a-n and 210a-n comprise two or more “planes”, with low density memories having a single plane while higher density memories comprise two, four or more planes. In multi-plane devices, it is possible for all of the planes to carry out a command in parallel. Multi-plane operation, when available, can substantially improve memory performance. Physical locations within the memories can be used by processor 102 to define a particular non-volatile memory and an address space within the particular non-volatile memory to store and retrieve data, by determining a channel, bank, plane, starting address, offset and size, as will be explained in further detail later herein.

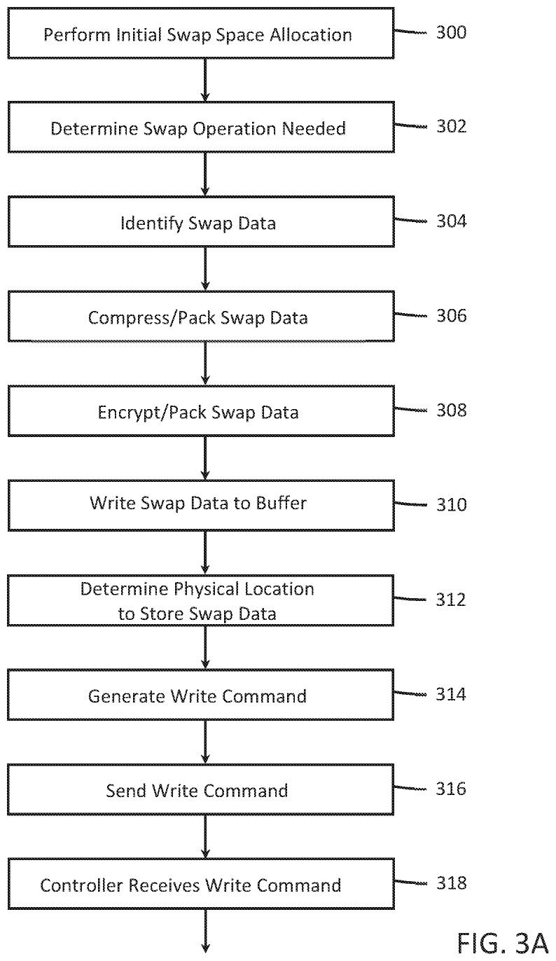

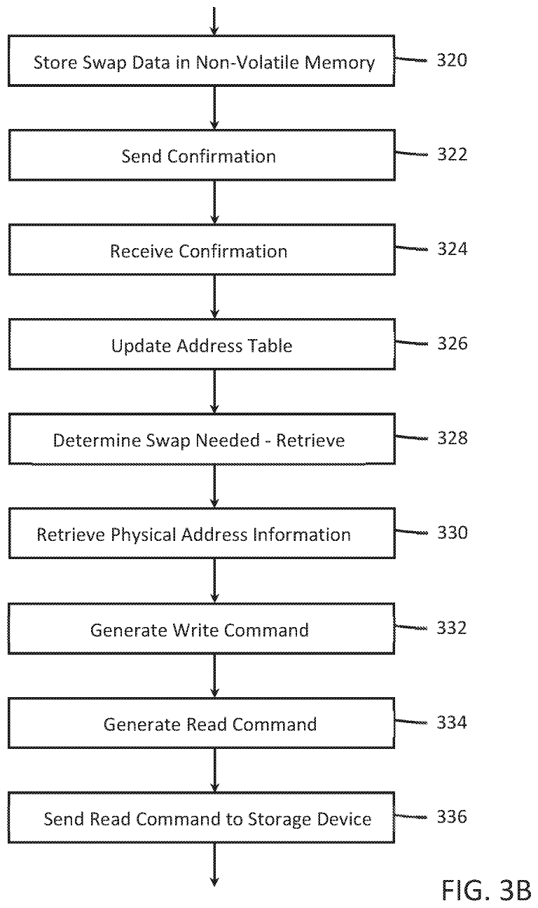

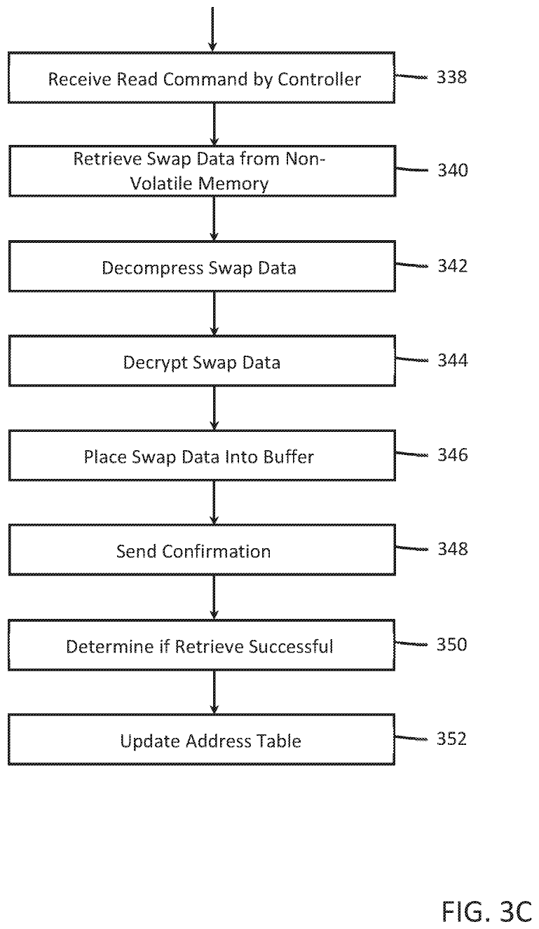

FIG. 3 is a flow diagram illustrating one embodiment of a method performed by host processor 102 and data storage device 110 to provide low-latency data storage and retrieval. The method is implemented by host processor 102 and controller 200, executing processor-executable instructions stored in memory 104 and memory 202, respectively. It should be understood that although the method shown in FIG. 3 describes a memory swapping process using direct addressing of non-volatile memories 208a-n and 210a-n, normal, non-volatile storage operations using prior art techniques may be occurring contemporaneously with the swapping process. It should further be understood that in some embodiments, not all of the steps shown in FIG. 3 are performed and that the order in which the steps are carried out may be different in other embodiments. It should be further understood that some minor method steps have been omitted for purposes of clarity.

The method is sometimes described in reference to use of the NVMe protocol over a computer's PCIe bus, which allows host processor 102 to communicate with data storage device 110, in this example, an internal SSD. However, it should be understood that other protocols could alternatively be used in a similar fashion to achieve the same low-latency read and write benefits as with NVMe.

NVMe is a storage interface specification for Solid State Drives (SSDs) on a PCIe bus. The NVMe protocol provide for both read and write commands, used by prior art computers to store and retrieve information to/from data storage device 110. However, NVMe also provides for customizable vendor-specific commands. In one embodiment, customized, vendor-specific read and write commands are defined to achieve low-latency read and write operations. A vendor-specific command is shown below, defined by the NVMe specification as FIG. 12:

Command Format−Admin and NVM Vendor Specific Commands

| Bytes | Description |
|---|---|
| 03:00 | Command Dword 0 (CDW0): This field is common to all commands and is defined in FIG. 10. |
| 07:04 | Namespace Identifier (NSID): This field indicates the namespace ID that this command applies |
| | to. If the namespace ID is not used for the command, then this field shall be cleared to 0 h. Setting |
| | this value to FFFFFFFFh causes the command to be applied to all namespaces attached to this |
| | controller, unless otherwise specified. |
| | The behavior of a controller in response to an inactive namespace ID for a vendor specific |
| | command is vendor specific. Specifying an invalid namespace ID in a command that uses the |
| | namespace ID shall cause the controller to abort the command with status Invalid Namespace or |
| | Format, unless otherwise specified. |
| 15:08 | Reserved |
| 39:16 | Refer to FIG. 11 for the definition of these fields. |
| 43:40 | Number of Dwords in Data Transfer (NDT): This field indicates the number of Dwords in the |
| | data transfer. |
| 47:44 | Number of Dwords in Metadata Transfer (NDM): This field indicates the number of Dwords in |
| | the metadata transfer. |
| 51:48 | Command Dword 12 (CDW12): This field is command specific Dword 12. |
| 55:52 | Command Dword 13 (CDW13): This field is command specific Dword 13. |
| 59:56 | Command Dword 14 (CDW14): This field is command specific Dword 14. |
| 63:60 | Command Dword 15 (CDW15): This field is command specific Dword 15. |

In one embodiment, each vendor-specific command consists of 16 Dwords, where each Dword is 4-bytes long. (so, the command itself is 64-bytes long.) The contents of the first ten Dwords in the command are pre-defined fields. The next two Dwords (Dword 10 and Dword 11) describe the number of Dwords in the data and the metadata being transferred. The last four Dwords in the command are used to provide task-specific instructions from host processor 102 to controller 200.

At block 300, host processor 102 performs an initialization process with data storage device 110 when data storage device 110 is first introduced into computer system 100, or at some other, later time, for example in response to user input. The initialization process comprises processor 102 allocating a portion of the non-volatile memory as “swap memory space” after data storage device 110 “advertises” the physical attributes to processor 102. The swap memory space may be defined by one or more physical attributes of non-volatile memories 208a-n and 210a-n, described below. During this allocation process, data storage device 110 provides processor 102 with an identification of each of the physical memory spaces, comprising one or more physical addresses, a total address space size of the non-volatile memories 208a-n and 210a-n, sizes of individual non-volatile memories, etc. that are used by controller 200 to directly access the memory space(s) during swap operations and, in some embodiment, during normal read and write operations to store data to data storage device 110 for long-term storage. The identification of the physical memory space may also include a bank, channel and/or plane information of the non-volatile memories in an embodiment where non-volatile memories 208a-n and 210a-n comprise NAND flash memory. Processor 102 receives the physical memory identification from data storage device 110 and then allocates a portion of this space as swap memory space by storing one or more physical memory addresses and/or other attributes to identify the swap memory space, such as the size, bank, channel, plane of one or more of the non-volatile memories 208a-n and 210a-n and stores this information into host memory 104.

In one embodiment, processor 102 may request additional swap memory space at some time after an initial amount of swap memory space has been allocated, as described above. In this embodiment, processor 102 may determine that additional swap memory space is needed, for example, when a previous amount of swap memory space is, or may soon be, consumed by active applications and application data. For example, if an initial swap memory space is nearly full, processor may determine that additional swap memory space is needed when a user launches another application.

When processor 102 determines that additional swap space is needed, in one embodiment, processor 102 queries data storage device 110 to determine a current state of data storage device 110, i.e., how much storage space is currently available in non-volatile memories 208a-n and 210a-n, and an identification of unused physical memory, such as one or more physical addresses, banks, channels and/or plane information of unused portions of the non-volatile memories 208a-n and 210a-n where the available memory is located. When controller 200 receives the query from processor 102, controller 200 may consult a table stored in a controller memory to determine which memory space is unused, based on previous storage and retrieval. Controller may then send a response to processor 102 with the identification of unused memory.

In another embodiment, processor 102 identifies where in non-volatile memories 208a-n and 210a-n additional swap space will be allocated based on previous storage and retrieval operations. In one embodiment, such previous storage and retrieval operations are memorialized in an address table stored in memory 104 that keeps track of memory space that is currently in use, i.e., where data has been previously stored, and/or memory space that is available for either general, long-term non-volatile storage and/or available for use as swap space.

In any case, processor 102 may then allocate additional memory as swap space based on available memory resources of non-volatile memories 208a-n and 210a-n, reducing the amount of storage space on data storage device 110 for non-volatile storage. Alternatively, processor 102 may allocate less space swap space that what is presently allocated.

In one embodiment, after the swap space has been allocated, processor 102 may initialize one or more I/O submission queues 204, one or more I/O completion queues 206, as well as one or more administrative queues (not shown) within memory 202 of data storage device 110, buffer 212, or controller buffer memory, knowing the size and physical layout of non-volatile memories 208a-n and 210a-n. These queues, and their creation, are described by the NVMe protocol. In one embodiment, processor 102 may create submission/completion queues specifically designated for swap operations, as well as other submission/completion queues specifically designated for normal, long term storage operations.

At block 302, processor 102 may determine that a swap operation is necessary, because memory 104 does not have unused capacity to open a new application, or to store application specific data. Such a determination is well-known in the art.

At block 304, in response to determining that a swap operation is necessary, processor 102 identifies one or more application instructions and/or application data in host memory 104 that have been unused recently as the data to be swapped (i.e., “swap data”). In one embodiment, processor 102 generates a 4 kB or 8 kB page of swap data, as is well-known in the art.

At block 306, processor 102 may compress the swap data using a particular compression algorithm stored in memory 104, such as the well-known Lempel-Ziv-Welch algorithm, the jpeg compression algorithm, or one of many others. In some embodiments, compression is performed by a specialized processor or “compression engine”. After compression, the swap data is typically much smaller in size, in one embodiment, just 64 bytes long, so that, in general, processor 102 may need to identify additional swap data in order to form, fill, or “pack” a page of swap data that is less than or equal in size to a physical memory page size of the non-volatile memories 208-210, typically 4 k bytes or 8 k bytes in size. Processor 102 may pack a page with a combination of compressed and/or uncompressed swap data.

At block 308, processor 102 may encrypt the swap data, or the compressed swap data, using an encryption algorithm and an encryption key stored in host memory 104. In some embodiments, encryption is performed by a specialized processor or “encryption engine”. Popular encryption algorithms include the well-known Advanced Encryption Standard (AES), Data Encryption Standard (DES), and others. Such encryption algorithms often rely on a private key to perform encryption and one or more public keys for decryption. The result of the encryption process is that encrypted swap data is generated or, in another embodiment where compressed swap data was encrypted, encrypted, compressed swap data. Again, as in the compression step, processor 102 may perform the encryption process on further swap data to fill a physical page size of the non-volatile memories 208-210.

It should be understood that sometimes, the swap data (and variants thereof such as compressed swap data, encrypted swap data, and encrypted and compressed swap data) may span more than one physical page memory.

At block 310, in one embodiment, processor 102 writes the swap data to buffer memory 114 and allocates the space in host memory 104 where the page frame was generated as free space.

At block 312, processor 102 determines where in data storage device 110 the swap data will be stored. In one embodiment, processor 102 maintains an address table, which identifies the physical memory addresses in the non-volatile memories 208a-n or 210 a-n where processor 102 has previously stored other swap data. Processor 102 selects an unused space within the non-volatile memories 208 a-n or 210a-n where the volume of swap data will fit, based on the size of the swap data and the information in the address table.

At block 314, processor 102 generates a write command for storing the swap data into data storage device 110 in a location of one of the non-volatile memories 208a-n or 210a-n where the swap data will fit. In one embodiment, the write command comprises some or all of the swap data, and physical location information identifying a physical location within the selected non-volatile memory 208a-n or 210a-n where the swap data will be stored. In another embodiment, the swap data is sent by processor 102 independent of the write command and stored in buffer memory 212 by controller 200. The physical location information generally comprise a physical starting address of one of the non-volatile memories 208a-n or 210a-n, an offset and a size, or volume, of the swap data. The physical location information may also comprise a bank, channel and/or plane information of the selected non-volatile memory in an embodiment where non-volatile memories 208a-n and 210a-n comprise NAND flash memory.

In another embodiment, the write command comprises a customized NVMe vendor-specific write command, where one or more of Dwords 12-15 comprise an indication that the customized vendor-specific command is a write command and the physical location information identifying where in non-volatile memories 208a-n or 210a-n the swap data should be stored. Also provided, typically, is a location within buffer memory 114 or host memory 104 where controller 200 can fetch the swap data, in one embodiment, in bytes 24-39 of the customized, vendor-specific write command. In another embodiment, some or all of Dwords 12-15 comprise some or all of the swap data.

At block 316, processor 102 sends the write command to data storage device 110 via data storage interface 108, information bus 112 and host interface 204, where it is received by computer interface 204 and stored in buffer memory 212 by controller 200. In another embodiment, processor 102 sends the customized vendor-specific write command to one of the I/O submission queues 204a-204n in memory 202. In this embodiment, the write command may additionally comprise an address of a particular I/O submission queue within memory 202 in which to store the customized vendor-specific write command.

At block 318, controller 200 retrieves the swap data for storage. In one embodiment, controller 200 retrieves the swap data from buffer memory 212 in an embodiment where the swap data was sent by processor 102 either separately from the write command, or within numerous write commands. In another embodiment, where the NVMe protocol is being used, controller 200 retrieves the swap data from memory 104, or buffer 114, via host interface 204, information bus 112, and data storage interface 108, in accordance with the address information provided in the customized vendor-specific write command. In one embodiment, controller 200 may poll one or more of the submission queues 204a-n at predetermined time intervals or, in another embodiment using NVMe, upon the occurrence of a particular event, such as receipt of a “doorbell” notification or other interrupt from processor 102, to determine when swap data is available for storage. Controller 200 may determine when swap data is available in an embodiment where controller 200 comprises its own memory buffer. In this embodiment, the swap data is received by controller 200 from host interface 204, and then controller 200 writes the swap data to an I/O submission queue in its controller memory buffer. As such, controller 200 knows that swap data is available for storage into one or more of the non-volatile memories 208a-n/210a-n simply by receiving the swap data from host interface 204. Thus, processor 102 does not send doorbell notifications to controller 200 to alert controller 200 to the presence of swap data.

At block 320, controller 200 stores the swap data into one of the non-volatile memories 208a-n or 210a-n using the physical address information in the customized vendor-specific write command, where the physical address information may comprise a physical starting address, a size, a bank, a channel, and/or a plane of the selected non-volatile memory 208a-n or 210a-n. There is no need for controller 200 to perform a conversion of a virtual page address into a physical page address of the non-volatile memories because processor 102 addresses the non-volatile memories directly using the physical location information, without the use of virtual page addressing.

At block 322, controller 200 may send a confirmation to processor 102 that some, or all, of the swap data has been successfully stored within the particular non-volatile memory. In one embodiment, this is accomplished by controller 200 generating a completion queue entry and posting the completion queue entry to one of the I/O completion queues 206a-206n, in accordance with the NVMe protocol.

At block 324, processor 102 receives the confirmation from controller 200. In one embodiment, processor 102 receives the confirmation as an interrupt. In another embodiment, processor 102 polls one or more of the I/O completion queues, either at predetermined time periods, or upon the occurrence of an event, such as when processor 102 is not busy processing requests from the applications running on computer system 100. If a completion queue entry is found, processor 102 retrieves the completion queue entry and determines if the swap data was successfully stored in data storage device.

At block 326, processor 102 may update the address table to indicate that the swap data was successfully stored within data storage device 110, and the physical address information in the non-volatile memories 208-210 where the swap data was stored.

At block 328, processor 102 may determine that a swap operation is needed to retrieve swap data from data storage device 110 because, for example, a user has provided an indication to processor 102 to access an application that had previously been swapped into data storage device 110. Such a determination is well-known in the art.

At block 330, in response to determining that a swap operation is necessary, processor 102 retrieves the physical location information in the addressing table that identifies where in the non-volatile memories 208a-n and 210a-n the swap data was previously stored. It should be understood that sometimes, the swap data may span more than one physical memory page within a particular non-volatile memory 208a-n or 210a-n.

At block 332, in one embodiment, processor 102 may generate a write command to store application instructions and/or application data from memory 104 into data storage device 110, in an amount that will allow the swap data from data storage device 110 to be written into host memory 104.

At block 334, processor 102 generates a read command for retrieving the swap data from data storage device 110 to a location in buffer memory 114 or host memory 104. In one embodiment, the write command comprises the physical location information identifying a physical location within one of the non-volatile memories 208a-n or 210a-n where the swap data was previously stored, in accordance with the address table. The physical location information generally comprise a physical starting address of one of the non-volatile memories 208a-n or 210a-n, an offset and a size, or volume, of the swap data. The physical location information may also comprise a bank, channel and/or plane information of the non-volatile memory where the swap data is located in an embodiment where non-volatile memories 208a-n and 210a-n comprise NAND flash memory.

In another embodiment, the read command comprises a customized NVMe vendor-specific read command, where one or more of Dwords 12-15 comprise an indication that the customized vendor-specific command is a read command and the physical location information identifying where in non-volatile memories 208a-n or 210a-n the swap data can be found. Also provided, typically, is a location within buffer memory 114 or host memory 104 where controller 200 can store the swap data once it has been retrieved from the particular non-volatile memory, in one embodiment, in bytes 24-39 of the customized, vendor-specific read command.

In one embodiment, the customized vendor-specific read command may comprise an identification of a decompression algorithm to decompress the swap data, and/or a decryption key and an identification of a decryption algorithm to decrypt the swap data, if the swap data had previously been compressed or encrypted by processor 102 prior to storage by data storage device 110. In another embodiment, one or more other customized vendor-specific commands may be defined to provide decompression and/or decryption information to controller 200.

At block 336, processor 102 sends the read command to data storage device 110 via data storage interface 108, information bus 112 and host interface 204, where it is received by computer interface 204 and stored in buffer memory 212 by controller 200. In another embodiment, processor 102 sends the customized vendor-specific read command to one of the I/O submission queues 204a-204n in memory 202. In this embodiment, the read command may additionally comprise an address of a particular I/O submission queue within memory 202 in which to store the customized vendor-specific read command. Controller 200 may poll one or more of the submission queues 204a-n at predetermined time intervals, or upon the occurrence of a particular event, to determine when to retrieve swap data.

At block 338, controller 200 receives the read command, and any decompression or decryption information from processor 102. In one embodiment, controller 200 polls one or more of the I/O submission queues, either at predetermined time periods, or upon the occurrence of an event, such as receiving an interrupt or when controller 200 not busy, in order to receive the read command and/or any decompression or decryption information. In another embodiment, where the I/O submission queues are created in a controller memory buffer of controller 200, controller 200 receives the read command directly from computer system interface 204.

At block 340, controller 200 retrieves the swap data from the non-volatile memory location specified in the read command using the physical location information in the read command. No address translation is necessary, since the physical location information defines the location of the swap data in terms of one of the non-volatile memories.

At block 342, controller 200 may decompress the swap data using a particular decompression algorithm stored in memory 202, in accordance with the read command or a separate command. Such decompression algorithms may include the well-known Lempel-Ziv-Welch algorithm, the jpeg compression algorithm, or one of many others. In some embodiments, decompression is performed by a specialized processor or “compression engine” within data storage device 110.

At block 344, controller 200 may decrypt the swap data, or the decompressed swap data, using a decryption algorithm and a decryption key stored in memory 202, in accordance with the read command or a separate command. In some embodiments, decryption is performed by a specialized processor or “decryption engine”. Popular decryption algorithms include the well-known Advanced Encryption Standard (AES), Data Encryption Standard (DES), and others. The result of the decryption process is that decrypted swap data is generated.

At block 346, in one embodiment, controller 200 places the swap data (including decompressed/decrypted swap data) from the non-volatile memory(ies) into buffer memory 212. Then, as some later time, controller 200 provides the swap data to buffer memory 114 or host memory 104 via computer interface 204, information bus 112, and data storage interface 108. In another embodiment, where the NVMe protocol is being used, controller 200 provides the swap data from the non-volatile memory to buffer 114 or host memory 104 in accordance with address information provided in the customized vendor-specific read command.

At block 348, controller 200 may send a confirmation to processor 102 that some, or all, of the swap data has been successfully provided to buffer memory 114 or host memory 104. In one embodiment, this is accomplished by controller 200 generating a completion queue entry and posting the completion queue entry to one of the I/O completion queues 206a-206n, in accordance with the NVMe protocol.

In one embodiment, at block 450, processor 102 checks one or more of the completion queues 206a-206n to determine if controller 200 generated a completion queue entry, indicating that the swap data has been successfully provided to buffer memory 114 or host memory 104. In one embodiment, processor 102 polls one or more of the I/O completion queues, either at predetermined time periods, or upon the occurrence of an event, such as when processor 102 is not busy processing requests from the applications running on computer system 100. If a completion queue entry is found, processor 102 retrieves the completion queue entry and determines if the swap data was successfully stored in buffer memory 114 or host memory 104.

At block 352, processor 102 may update the address table to indicate that the swap data was successfully stored within buffer memory 114 or host memory 104, and that the physical memory space in the particular non-volatile memory from where the swap data was retrieved is now free to accept other swap data from processor 102.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A computer system coupled to a data storage device, comprising:
a data storage device interface;
a data storage device coupled to the data storage interface, comprising a non-volatile memory for storing swap data associated with one or more applications being executed by the computer system;
a memory for storing processor-executable instructions comprising operating system instructions, application instructions associated with the one or more applications and application data;
a processor coupled to the data storage device interface and the memory for executing the processor-executable instructions that causes the computer system to:
determine, by the processor, a need to swap some of the application instructions and/or the application data in the memory to the data storage device;
in response to determining a need to store some of the application instructions and/or the application data, identify, by the processor, a quantity of the application instructions and/or the application data for storage to the data storage device as swap data;
determine, by the processor, a physical location in the non-volatile memory where the swap data will be stored, the physical location comprising a physical address of the non-volatile memory;
generate, by the processor, a write command comprising the physical location; and
send, by the processor, the write command to the data storage device via the data storage device interface.

2. The computer system of claim 1, wherein the write command comprises a customized NVMe vendor-specific write command.

3. The computer system of claim 2, wherein the non-volatile memory comprises a plurality of NAND flash memory chips arranged in banks and channels, and the physical location comprises an identification of a channel and a bank associated with one of the NAND flash memory chips where the swap data will be stored.

4. The computer system of claim 2, further comprising:
a buffer memory coupled to the processor;
wherein processor-executable instructions further comprise instructions that cause the computer system to:
store the swap data in the buffer memory starting at a first address in the buffer memory, wherein the write command further comprises the first address;
create, by the processor, a plurality of I/O submission queues and I/O completion queues in a memory of the data storage device; and
store, by the processor via the data storage device interface, the write command in one of the I/O submission queues in the data storage device;
wherein the data storage device retrieves the swap data from the buffer memory and stores the swap data in the non-volatile memory using the physical location in the customized vendor-specific write command.

5. The computer system of claim 1, wherein the processor-executable instructions further comprise instructions that cause the computer system to:
determine, by the processor, an identification of a swap space within the non-volatile memory for storing the swap data, the swap space defined by one or more physical attributes of the non-volatile memory.

6. The computer system of claim 1, further comprising:
a buffer memory coupled to the processor;
wherein processor-executable instructions further comprise instructions that cause the computer system to:
compress, by the processor, the swap data to form compressed swap data;
determine a size of the compressed swap data; and
store the compressed swap data in the buffer memory;
wherein the write command comprises the size of the compressed swap data.

7. The computer system of claim 6, wherein the processor-executable instructions further comprise instructions that cause the computer system to:
form a page of swap data from the compressed swap data and other swap data, the page of swap data equal to a predetermined size of a memory page of the non-volatile memory.

8. The computer system of claim 1, further comprising:
a buffer memory coupled to the processor;
wherein processor-executable instructions further comprise instructions that cause the computer system to:
encrypt, by the processor, the swap data to form encrypted swap data;
determine a size of the encrypted swap data; and
store the encrypted swap data in the buffer memory;
wherein the write command comprises the size of the encrypted swap data.

9. The computer system of claim 1, wherein processor-executable instructions further comprise instructions that cause the computer system to:
determine, by the processor, a need to retrieve the swap data;
generate, by the processor, a read command comprising the physical location in the non-volatile memory where the swap data was stored;
send, by the processor via the data storage interface, the read command;
receive, by the processor via the data storage interface, the swap data from the data storage device.

10. The computer system of claim 9, wherein the data storage device comprises a plurality of NAND flash memory chips arranged in banks and channels, and the physical location comprises an identification of a channel and a bank associated with one of the NAND flash memory chips where the swap data was previously stored.

11. The computer system of claim 2, wherein processor-executable instructions further comprise instructions that cause the computer system to:
create, by the processor, a plurality of I/O submission queues and I/O completion queues in a memory of the data storage device; and
poll, by the processor, the plurality of I/O completion queues to determine if a completion queue entry is available from the data storage device.

12. The computer system of claim 5, wherein the instructions that cause the computer system to determine an identification of a swap space within the non-volatile memory comprise further instructions that cause the computer system to:
determine, by the processor, an identification of a second swap space after the swap space has been determined.

13. The computer system of claim 1, wherein the processor-executable instructions that causes the computer system to send the write command to the data storage device further comprises instructions that causes the computer system to:
refrain from sending a doorbell notification to the data storage device when the application instructions and/or the application data is ready to be stored on the data storage device.

14. A data storage device coupled to a computer system, for providing low-latency data storage and retrieval, comprising:
a computer interface;
a first non-volatile memory for storing swap data associated with one or more applications being executed by the computer system;
a memory for storing processor-executable instructions; and
a controller coupled to the computer interface, the first non-volatile memory and the memory, for executing the processor-executable instructions that cause the data storage device to:
receive, by the processor via the computer interface, a write command from the computer system, the write command comprising a physical location in the non-volatile memory where the swap data should be stored, the physical location comprising a physical address of the non-volatile memory;
receive, by the processor via the computer interface, the write command from the computer system; and
store the swap data in the first non-volatile memory in accordance with the physical address provided by the write command.

15. The data storage device of claim 14, wherein the write command comprises a customized NVMe vendor-specific write command.

16. The data storage device of claim 14, wherein the swap data comprises a quantity of encrypted swap data, and wherein processor-executable instructions further comprise instructions that cause the data storage device to:
receive, by the processor via the computer interface, a cryptographic key from the computer system;
receive, by the processor via the computer interface, a read command, the read command comprising a second physical address identifying a second physical address within the non-volatile memory to retrieve the encrypted swap data;
retrieve, by the processor, the swap data from the first non-volatile memory using the second physical address in the read command;
decrypt, by the processor, the encrypted swap data using the cryptographic key provided by the computer system to generate decrypted swap data; and
provide, by the processor via the computer interface, the decrypted swap data.

17. A method performed by a computer system coupled to a data storage device, comprising:
determining, by a processor, a need to store a quantity of application instructions and/or application data from a memory coupled to the processor to a data storage device;
in response to determining a need to store the quantity of the application instructions and/or application data in the memory to the data storage device, identifying, by the processor, some of the application instructions and/or application data as swap data to be stored in the data storage device;
determining, by the processor, a physical location in the non-volatile memory where the swap data will be stored, the physical location comprising a physical address of the non-volatile memory;
generating, by the processor, a write command comprising the physical address; and
sending, by the processor, the write command to the data storage device via a data storage device interface.

18. The method of claim 17, wherein the write command comprises a customized NVMe vendor-specific write command.

19. The method of claim 18, wherein the non-volatile memory comprises a plurality of NAND flash memory chips arranged in banks and channels, and the physical location comprises an identification of a channel and a bank associated with one of the NAND flash memory chips where the swap data will be stored.

20. The method of claim 18, further comprising:
storing, by the processor, the swap data in a buffer memory coupled to the processor starting at a first address in the buffer memory, wherein the write command further comprises the first address;
creating, by the processor, a plurality of I/O submission queues and I/O completion queues in a memory of the data storage device; and
storing, by the processor, the write command in one of the I/O submission queues in the data storage device;
wherein the data storage device retrieves the swap data from the buffer memory and stores the swap data in the non-volatile memory using the physical location in the customized vendor-specific write command.

21. The method of claim 17, further comprising:
compressing, by the processor, the swap data to form compressed swap data;
determining a size of the compressed swap data; and
storing the compressed swap data in a buffer memory coupled to the processor;
wherein the write command comprises the size of the compressed swap data.

22. The method of claim 17, further comprising:
encrypting, by the processor, the swap data to form encrypted swap data;
determining a size of the encrypted swap data; and
storing the encrypted swap data in a buffer memory;
wherein the write command comprises the size of the compressed swap data.

23. The method of claim 17, further comprising:
determining, by the processor, a need to retrieve the swap data from the data storage device;
generating a read command comprising the physical address in the non-volatile memory where the swap data was stored;
sending, by the processor, the read command;
receiving, by the processor, the swap data from the data storage device.

24. The method of claim 17, wherein the non-volatile memory comprises a plurality of NAND flash memory chips arranged in banks and channels, and the physical location comprises an identification of a channel and a bank associated with one of the NAND flash memory chips where the swap data will be stored.

25. The method of claim 18, further comprising:
creating, by the processor, a plurality of I/O submission queues and I/O completion queues in a memory of the data storage device; and
polling, by the processor, the plurality of I/O completion queues to determine if a completion queue entry is available from the data storage device.
